(19) United States
(12) Patent Application Publication
(10) Pub. No.: US 2026/0061534 A1
(43) Pub. Date: Mar. 5, 2026

(54) MACHINING SYSTEM WITH EXPANDABLE MACHINING BED

(71) Applicant: Van Norman Machine India PVT LTD, Chandigarh (IN)

(72) Inventor: RANJIT (ROBIN) CHERA, Chandigarh (IN)

(21) Appl. No.: 18/923,701

(22) Filed: Oct. 23, 2024

(30) Foreign Application Priority Data
Sep. 4, 2024 (IN) 202411066987

(51) Int. Cl. B23Q 1/01

(52) U.S. Cl. CPC B23Q 1/015

(57) ABSTRACT

A machining system having an expandable machining bed for performing machining operations is disclosed. The machining system includes a base having an expandable machining bed. The machining system includes a plurality of fixtures positioned on the machining bed. The plurality of fixtures is configured to secure a plurality of workpieces. The machining system includes at least one working head positioned above the machining bed. The at least one working head is configured to perform machining operations independently and different from one another on one or more workpieces of the plurality of workpieces. The machining system is capable of performing boring, honing, valve seat cutting and guiding, and surfacing operations simultaneously on different workpieces or sequentially on a single workpiece. The machining system eliminates repeated setups, and minimizes downtime between different machining operations. Further, the machining system significantly reduces setup time and improves overall machining productivity.

### CROSS-REFERENCE TO RELATED APPLICATION

This application is based upon and claims priority from, Application No. IN 202411066987, filed on 4Sep. 2024 the entireties which are incorporated herein by reference for all purposes.

### FIELD OF THE INVENTION

The present invention relates to machines and machine tools, and in particular, to a machining system having an expandable machining bed with multiple fixtures for efficiently performing machining operations on multiple workpieces.

### DESCRIPTION OF THE PRIOR ART

Traditional machines consist of a single working head to perform an operation on a workpiece. For example, in a cylinder boring machine, a single tool is connected to the working head for performing precise boring operation. Further, a cylinder head resurfacing machine is used for grinding the surface of the cylinder head to achieve a perfectly flat and smooth finish. The traditional machines are restricted to perform only one operation at a time, such as boring, honing, surfacing, or valve seat cutting and guiding operations. As such, they require multiple tool changes, and manual loading and unloading when a series of different operations need to be performed on a single workpiece.

In addition, the traditional machines have a fixed work bed or machining bed that comes in a prefixed size. As such, they can only hold one workpiece at a time. In other words, the traditional machines lack the capability to accommodate multiple workpieces of varying sizes.

The traditional machine having a single working head and a fixed machining bed presents several challenges. For example, the manual loading and unloading when a series of different operations need to be performed on the single workpiece may lead to errors and misalignments. The misalignment may affect the required finishing on the workpiece. Further, the fixed machining bed is typically designed to accommodate only a single fixture that can secure a single workpiece. As a result, the traditional machine limits the number and type of workpieces/jobs that can be accommodated on the machining bed, thereby restricting the number and type of workpieces/jobs that can be processed simultaneously. For instance, when different machining operations are required for various workpieces, say boring operations and surface finishing operation on different cylinder heads, then an operator has to unload the completed workpieces and load new ones. This constant loading and unloading of the workpieces is prone to errors, increases the time to process the jobs, reduces overall productivity, and increases the risk of damage to the workpieces.

Therefore, there is a need in the art to provide a machining system with an expandable machining bed capable of accommodating multiple fixtures for efficiently performing multiple machining operations simultaneously or sequentially on a variety of workpieces.

### SUMMARY OF THE INVENTION

It is an object of the present invention to provide a machining system having an expandable machining bed for performing multiple machining operations simultaneously or sequentially on multiple workpieces.

It is another object of the present invention to provide a machining system capable of performing multiple operations such as boring, honing, valve seat cutting and guiding, and surfacing operations within a single machining system.

It is another object of the present invention to provide a machining system that allows sequential operations on a single workpiece without repositioning and reduces setup time.

It is another object of the present invention to provide a machining system that integrates the functionalities of cylinder boring machine, honing machine, valve seat cutting and guide machine, and cylinder head resurfacing machine into a single machining system.

It is yet another object of the present invention to provide a machining system that allows simultaneous and different operations on multiple workpieces.

In order to achieve one or more objects, the present subject matter provides a machining system having an expandable machining bed for performing machining operations. The machining system includes a base having an expandable machining bed. The expandable machining bed comes as a single elongated machining bed or multiple machining beds. The machining bed encompasses rails that run along its length. The rails accommodate a plurality of fixtures that can slide and secure a plurality of workpieces.

Further, the machining system includes one or more working heads positioned above the machining bed. Each working head is independently slidable along the x plane/axis and includes a tool holder or spindle. The one or more working heads are configured to perform machining operations independently and different from one another on one or more workpieces. The multiple working heads and the slidable fixtures allow the machining system to perform different machining operations either simultaneously on multiple workpieces or sequentially on a single or multiple workpieces without the need for repositioning.

In one example, the machining system offers a 2-in-1, say boring and surfacing capabilities with a single machine. The machining system makes it easy to switch from cylinder boring to surfacing within seconds. Alternatively, the machining system allows for the simultaneous use of V-block cylinder fixtures and cylinder head tilt fixtures, enabling flexibility in fixture setup and machining operations. Further, the machining system provides a servo control system or controller for operating the respective working heads. In another example, the machining system is configured to perform multiple machining operations by interchanging the number of machining beds, fixtures, workpieces, working heads and tools depending on the need. Here, the machining system can be used to perform boring, honing, valve seat cutting and guiding, and surfacing operations simultaneously on different workpieces.

In some implementations, the machining system presents a single expandable bed that can be extended based on the need to place one or more fixtures for securing workpieces. This allows multiple configurations of the machining system. For instance, the machining system can have a single expandable bed having a single workpiece. Here, a single working head is aligned to perform a single operation, say, boring operation on the workpiece. In another instance, the machining system can have a single expandable bed having a single workpiece which requires multiple operations. In such scenario, one or more spindles are connected in series to the working head. The spindles are used to perform one or more operations say, boring and surfacing operations in series on the workpiece. Here, the spindles are interchanged to perform different type of operations on the workpiece. The additional space/remaining space on the expandable bed can be used to position one or more fixtures to receive one or more processed or unprocessed workpieces. Once the operation is completed, then processed workpiece can be made to slide along the expandable bed to position another workpiece to perform a machining operation with the help of the working head.

In yet another instance, machining system can have one or more expandable beds placed as guideways at the bottom, and two or more working heads slidably positioned at the top. Here, two or more fixtures connecting respective workpieces are positioned over the one or more expandable beds. The working heads are operated independently and different from one another, either simultaneously or sequentially to perform multiple operations on the workpieces. The additional space/remaining space on the expandable bed can be used to position one or more fixtures to receive one or more processed or unprocessed workpieces. Once the operations are completed, then processed workpieces secured to the fixtures are made to slide along the expandable bed to position another workpiece to perform a machining operation with a working head of the working heads.

In one advantageous feature of the present subject matter, the machining system is capable of performing boring, honing, seat cutting and guiding, and surfacing operations on different workpieces simultaneously or sequentially on a single workpiece. This significantly reduces setup time and improves overall machining productivity. The machining system eliminates repeated setups, and minimizes downtime between different machining operations.

In another advantageous feature of the present subject matter, the machining system is capable of performing multiple operations on a single workpiece without removal or realignment. For example, the machining system can perform a boring operation on a cylinder block using the working head integrating a tool insert, and then slide the second working head into position for surfacing operations on the cylinder block, without moving the workpiece/cylinder block.

In yet another advantageous feature of the present subject matter, the expandable nature of the machining bed allows for simultaneous processing of different operations on different workpieces. This significantly reduces repeated setups, reduces downtime between operations, and minimizes the risk of workpiece damage due to frequent handling.

These and other objects of the present invention will be apparent from review of the following specification and the accompanying drawings.

### BRIEF DESCRIPTION OF THE DRAWINGS

FIG. 1 is a first side perspective view of a machining system having an expandable machining bed and multiple working heads, in accordance with one exemplary embodiment of the present subject matter.

FIG. 2 is a second side perspective view of the machining system having the expandable machining bed and multiple working heads, in accordance with one exemplary embodiment of the present subject matter.

FIG. 3 is a side perspective view of the machining system, in accordance with one exemplary embodiment of the present subject matter.

FIG. 4 is a side perspective view of a first working head aligned with a workpiece for performing a boring operation, in accordance with one exemplary embodiment of the present subject matter.

FIG. 5 is a side perspective view of a second working head aligned with a workpiece for performing a surfacing operation, in accordance with one exemplary embodiment of the present subject matter.

FIG. 6A and FIG. 6B show a top perspective view and a side perspective view, respectively of a first boring tool insert i.e., plato boring tool, in accordance with one embodiment of the present invention;

FIG. 7A and FIG. 7B show a top perspective view and a side perspective view, respectively of a second boring tool insert i.e., a traditional boring tool, in accordance with one embodiment of the present invention;

FIG. 8 shows the first boring tool insert aligned with a tool holder, in accordance with one embodiment of the present invention;

FIG. 9 shows the first boring tool insert positioned in the tool holder, in accordance with one embodiment of the present invention;

FIG. 10 shows the traditional boring tool insert aligned with the tool holder, in accordance with one embodiment of the present invention;

FIG. 11 shows the traditional boring tool insert positioned in the tool holder and rotating in a clockwise direction, in accordance with one embodiment of the present invention; and

FIG. 12, FIG. 13, FIG. 14, and FIG. 15 show interfaces displayed on a display for controlling the operation of the first working head, in accordance with one embodiment of the present invention.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed machining system with expandable machining bed. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed machining system with expandable machining bed.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a machining system with expandable machining bed, it is to be further understood that numerous changes may arise in the details of the embodiments of the machining system with expandable machining bed. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

Various features and embodiments of a machining system having an expandable machining bed for performing machining operations simultaneously on multiple workpieces are explained in conjunction with the description of FIGURES (FIGS.) 1-15.

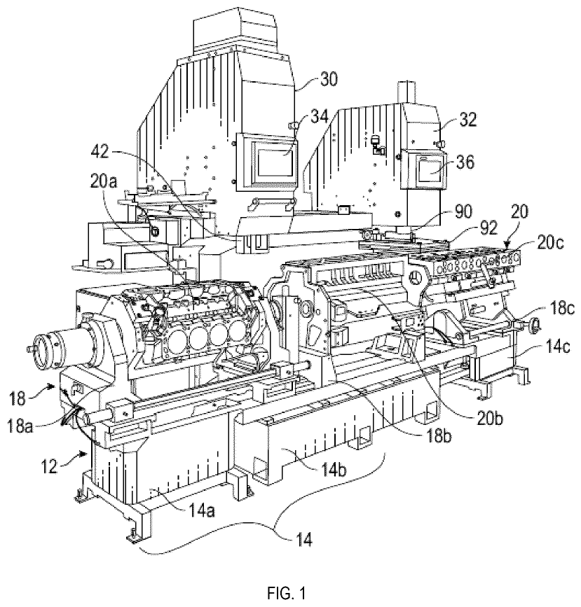

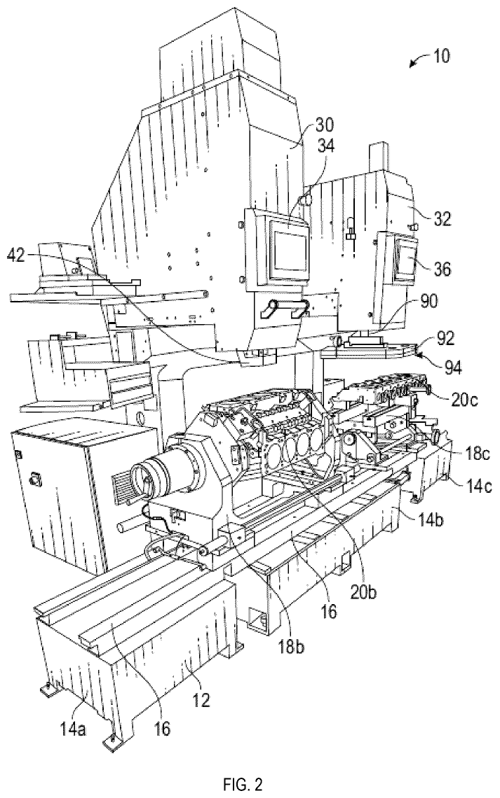

FIG. 1 shows a first side perspective view of a machining system 10 having a base or housing 12 with an expandable machining bed or workbench 14, in accordance with one exemplary embodiment of the present invention. Here, machining system 10 shows three machining beds or workbenches 14, say a first machining bed 14a, a second machining bed 14b, and a third machining bed 14c, collectively termed as a large/elongated/expandable machining bed 14 for ease of reference. Although it is shown that first machining bed 14a, a second machining bed 14b, and a third machining bed 14c are separate machining beds, it is possible to provide them as a single elongated machining bed 14 without departing from the scope of the present invention. Further, machining beds may be added or deleted from first machining bed 14a, second machining bed 14b, and third machining bed 14c to place unprocessed, and processed workpieces 20, or workpieces 20 that require machining depending on the need. First machining bed 14a, second machining bed 14b, and third machining bed 14c are selectively used in any order to place workpieces 20 via fixtures 18. A person skilled in the art understands that two or more machining beds 14 may be provided in continuation to adjust the length of elongated machining bed 14 for performing machining operations simultaneously on multiple workpieces 20. FIG. 2 shows a second side perspective view of machining system 10 in which two workpieces 20 are placed on machining bed 14. In some implementations, a single expandable machining bed 14 may be provided for performing multiple machining operations simultaneously on multiple workpieces 20. Each machining bed 14 is mounted on base 12 by way of an air cushion platform which provides movement along the x, y plane.

In one implementation, machining bed 14 includes rails 16. Rails 16 position above machining bed 14 as can be seen from FIG. 2, for example. Rails 16 run along the length of machining bed 14 and allow workpieces 20 connected via fixtures 18 to slide/move along. In one example, first machining bed 14a, second machining bed 14b, and third machining bed 14c includes a first fixture 18a, a second fixture 18b and a third fixture 18c, respectively. First fixture 18a, second fixture 18b and third fixture 18c, are collectively called as fixtures 18 or simply fixture 18. Each of first fixture 18a, second fixture 18b and third fixture 18c configures to receive/hold a first workpiece 20a, a second workpiece 20b, and a third workpiece 20c, respectively. For example, first workpiece 20a includes a cylinder block. Second workpiece 20b includes a cylinder head. Third workpiece 20c includes a V-block cylinder. As can be seen from FIG. 1 and FIG. 2, first fixture 18a, second fixture 18b and third fixture 18c position over rails 16 and configure to slide along rails 16. Each of first fixture 18a, second fixture 18b and third fixture 18c can come in different sizes and can be accommodated over rails 16 with the help of first fixture 18a, second fixture 18b and third fixture 18c. A person skilled in the art understands that three fixtures 18 are presented for illustration purposes and it is possible to provide add or remove one or more fixtures 18 to hold workpieces 20, depending on the number of working heads 30, 32 needed to perform a variety of machining operations on two or more workpieces 20; or number of unprocessed, and processed workpieces 20, or workpieces 20 that require machining to be placed over machining beds 14. For instance, first fixture 18a holds an unprocessed/processed first workpiece 18a, second fixture 18b holds second workpiece 20b such as cylinder block having cylinder bores 22 to be machined, and third fixture 18c holds third workpiece 20c to perform surfacing operation, as shown in FIG. 1. In one example, base 12 includes safety doors 24 with covers to prevent chip material and/or coolant from falling away from machining system 10.

Referring to FIG. 1 through FIG. 5, machining system 10 includes a plurality of working heads, i.e., two or more working heads. In one example, plurality of working heads includes a first working head 30, and a second working head 32 at the top of base 12 or machining bed 14. First working head 30 encompasses a first display 34 and second working head 32 encompasses a second display 36 for adjusting manual or automatic options for fine-tuning and making adjustments on the fly to operate machining system 10. Each of first working head 30, and second working head 32 is slidable along the x plane. In other words, each of first working head 30, and second working head 32 travel along X-axis (sideways) for positioning above workpieces 20. In the current invention, multiple working heads 30, 32 are used to perform different machining operations on the same workpiece 20 in series, or different machining operations on different workpieces 20 simultaneously. Each of first working head 30, and second working head 32 includes a separate motor or controller that helps to operate them individually.

Machining system 10 is configured to perform multiple machining operations by interchanging the number of machining beds 14, fixtures 18, workpieces 20, working heads 30, 60 and tool holders 40, 90 depending on the need. Machining system 10 can be configured to perform one of a boring operation, honing operation, valve seat cutting and guide operation, and surfacing operation. The machining operations may be performed simultaneously on different workpieces 20, or sequentially on a single workpiece 20 depending on the need. In one implementation, only first working head 30 can be used to perform multiple machining operations, say boring and surfacing operations. Here, second fixture 18b holding second workpiece 20b is placed on machining bed 14. First working head 30 is aligned with second workpiece 20b. Subsequently, a tool holder of first working head 30 is configured to perform boring operation on second workpiece 20b. After performing the boring operation, the tool holder of first working head 30 may be changed to perform surfacing operation. In one example, the surfacing operation is performed on second workpiece 20b using the first working head 30. This way, a single first working head 30 is used to perform multiple operations on a single workpiece 20.

In another implementation, only first working head 30 can be used to perform multiple machining operations, say boring operations in a sequential manner on different workpieces. Here, second fixture 18b holding second workpiece 20b and third fixture 18c holding third workpiece 20c are placed on machining bed 14. First workpiece 20a may be parked at one end of machining bed 14. First working head 30 is aligned with second workpiece 20b to perform a boring operation on second workpiece 20b. After performing the boring operation, first working head 30 is made to slide to align with third workpiece 20c. Subsequently, the boring operation is performed on third workpiece 20c using the first working head 30. This way, a single first working head 30 is used to perform same operation on multiple workpieces in series/sequentially

In another implementation, both first working head 30 and second working head 32 can be used to perform multiple machining operations simultaneously, say boring operation and surfacing operation simultaneously on different workpieces. Here, second fixture 18b holding second workpiece 20b and third fixture 18c holding third workpiece 20c are placed on machining bed 14. First workpiece 20a may be parked at one end of machining bed 14. First working head 30 is aligned with second workpiece 20b to perform a boring operation on second workpiece 20b. Concurrently, second working head 32 is aligned with third workpiece 20c to perform a surfacing operation.

In some implementations, first working head 30 is provided with a first tool holder or first spindle 40, second working head 32 is provided with a second tool holder or second spindle 90 to perform different machining operations. The present implementation is explained considering that first working head 30 includes a first tool holder 40 and second working head 32 includes a second tool holder 90, each configured to perform different machining operation while the fixtures are configured to hold different workpieces simultaneously. However, a person skilled in the art understands that the description is provided for illustrative purpose and working head 30, 32 having tool holders 40, 90 may be selectively used to perform one or more machining operations on workpieces 20, simultaneously or sequentially, while workpieces 20 are secured to fixtures 18 depending on the need.

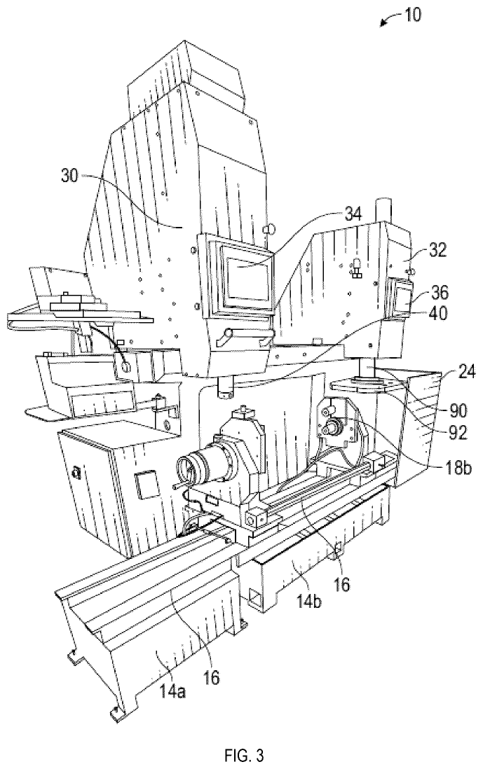

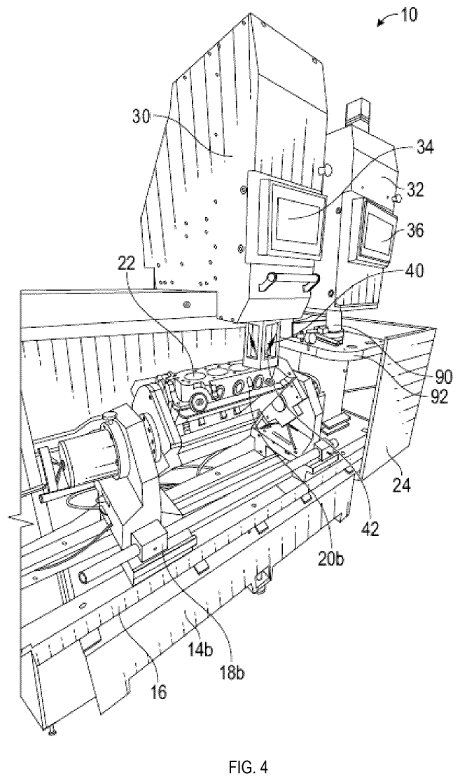

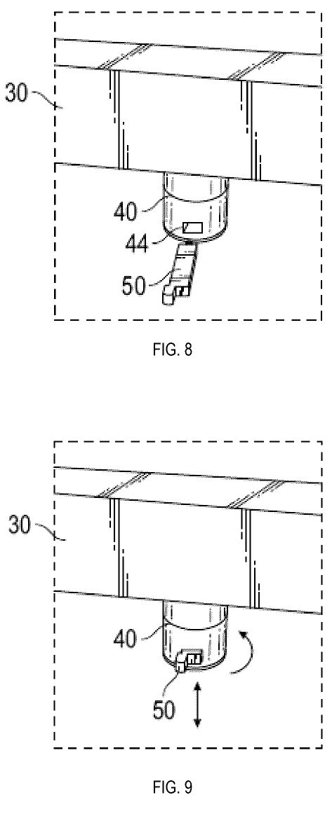

Referring to FIG. 3, first working head 30 having first tool holder or spindle 40 is shown. First tool holder 40 extends downward from first working head 30. In one example, first working head 30 includes a transparent shield 42 that selectively extends from first working head 30 and covers first tool holder 40 at the time of operation of first working head 30. FIG. 4 shows the feature of transparent shield 42 covering first tool holder 40. First tool holder 40 includes a tool receiving area 44, as can be seen from at least FIG. 8. Tool receiving area 44 indicates a hole configured for receiving a boring tool insert 50, 70. For ease of reference, boring tool insert 50 is referred to as a first boring tool insert 50, and boring tool insert 70 is referred to as a second boring tool insert 70 hereinafter. Optionally, first boring tool insert 50 may also be referred to as a plato boring insert or rough boring insert. Further, second boring tool insert 70 may be referred to as a plato fine insert or fine boring insert. In one example, second boring tool insert 70 indicates a traditional tool insert that is designed to be operated in a clockwise direction to smoothen the surface of cylinder bore 22. Each of first boring tool insert 50 and second boring tool insert 70 is made of carbide, ceramic, or cubic boron nitride (CBN) depending on the need.

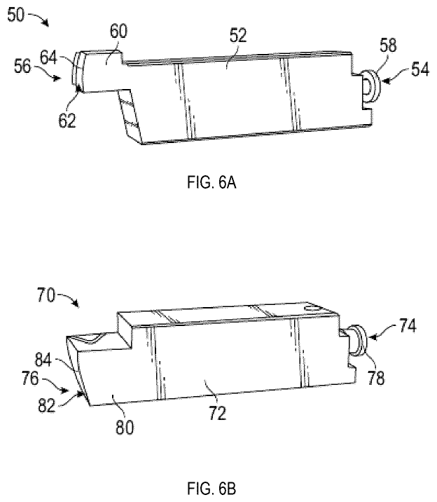

FIG. 6A and FIG. 6B show a top perspective view and a side perspective view, respectively of first boring tool insert 50, in accordance with one embodiment of the present invention. First boring tool insert 50 includes a first body or first insert body 52. First body 52 is made of hard and durable material such as carbide or any other suitable material. First body 52 comes in a substantially rectangular configuration. First body 52 provides structural support and stability during the machining process. First body 52 has a first end 54 and a second end 56. At first end 54, first body 52 has a first insert clamp or first clamp head 58. First insert clamp 58 extends from first body 52 and interacts with an insert connector (not shown) in first tool holder 40, when inserted through tool receiving area 44. First insert clamp 58 is configured to hold first boring tool insert 50 in place and maintain its position within first tool holder 40 during machining. First body 42 further includes a first extended section 60. First extended section 60 extends from first body 52 in a step-like configuration. First extended section 60 has a first cutting edge 62. First cutting edge 62 indicates a sharp and an active portion of first boring tool insert 50 that comes in contact with cylinder bore 22 during machining. In one embodiment, first cutting edge 62 is precisely machined to achieve a specific cutting geometry in cylinder bore 22.

Further, first cutting edge 62 has a first radius or first nose radius 64. First radius 64 has a round or curved configuration at the intersection of first cutting edge 62. In one example, the round or curved configuration at the intersection of first cutting edge 62 is configured to match the surface to be machined in order to improve machining of the bore surface. First radius 64 is configured to position (curved) in an anti-clockwise direction for operating first tool holder 40 in an anti-clockwise direction to machine cylinder bore 22. First radius 64 has a suitable smooth curve (i.e., suitable size of nose radius) in order to reduce stress concentrations on cylinder bore 22 and also to improve the durability of first boring tool insert 50. First radius 64 facilitates in achieving the precise machining performance (rough boring) in cylinder bore 22 to be machined. In addition, first extended section 60 has a first chip groove or first flute 66 at the bottom. First chip groove 66 helps to guide and control the flow of chips/torn and folded materials (TFM) away from a cutting zone during machining. In other words, first chip groove 66 helps to evacuate the chips or metallic debris removed during machining so that they do not come in contact with the surface to be machined or machined surface.

FIG. 9 shows first boring tool insert 50 aligned with tool receiving area 44 of first tool holder 40. Here, first boring tool insert 50 inserts through tool receiving area 44 and first insert clamp 58 connects to the insert connector of first tool holder 40. First boring tool insert 50 is tightened to properly secure first boring tool insert 50 to first tool holder 28. FIG. 9 shows the feature of first boring tool insert 50 positioned inside first tool holder 40.

In the present embodiment, first tool holder 40 is configured to rotate in anti-clock direction. This results in first boring tool insert 50 to rotate in the anti-clock direction such that first cutting edge 62 removes/chips away a portion of material from cylinder bore 22 in a rough boring cycle. When first boring tool insert 50 makes the subsequent pass, the chipped away material gets evacuated via first chip groove 66. This helps to avoid the chipped away material to come in contact with the surface of cylinder bore 22 to be machined/or already machined surface. As a result, the formation of torn and folded material (TFM) is eliminated.

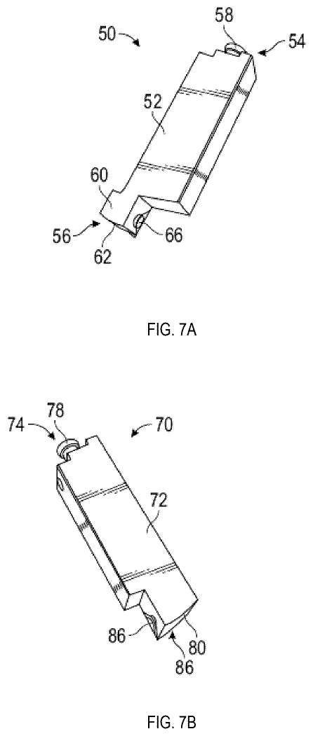

FIG. 7A and FIG. 7B show a top perspective view and a side perspective view, respectively of a second boring tool insert 70, in accordance with one embodiment of the present invention. As specified above, second boring tool insert 70 indicates a traditional boring tool that is configured to operate in a clockwise direction to remove material from cylinder bore 22. Second boring tool insert 70 includes a second body or second insert body 72. Second body 72 is made of hard and durable material such as carbide or any other suitable material. Second body 72 comes in a substantially rectangular configuration. Second body 72 provides structural support and stability during the machining process. Second body 72 has a third end 74 and a fourth end 76. At third end 74, second body 72 has a second insert clamp or second clamp head 78. Second insert clamp 78 extends from second body 72 and interacts with the insert connector (not shown) in second boring tool insert 70, when inserted through tool receiving area 44. Second insert clamp 78 is configured to hold second boring tool insert 70 in place and maintain its position within first tool holder 40 during machining. Second body 72 further includes a second extended section 80. Second extended section 80 extends from second body 72. Second extended section 80 has a second cutting edge 82. Second cutting edge 82 indicates a sharp and an active portion of second boring tool insert 70 that comes in contact with cylinder bore 22 during machining. In one embodiment, second cutting edge 82 is precisely machined to achieve a specific cutting geometry in cylinder bore 22. Further, second cutting edge 82 has a second radius or second nose radius 84. Second radius 84 has a round or curved configuration at the intersection of second cutting edge 82. Second radius 84 is configured to position in a clockwise direction for operating first tool holder 40 in the clockwise direction to machine cylinder bore 22. Second radius 84 has a suitable smooth curve (i.e., suitable size of nose radius) in order to reduce stress concentrations on cylinder bore 22 and also to improve the durability of second boring tool insert 70. Second radius 84 facilitates in achieving the precise machining performance and the surface finish (fine boring finish) in cylinder bore 22 to be machined. In addition, second extended section 80 has a second chip groove or second flute 86 at the bottom. Second chip groove 86 helps to guide and control the flow of chips/torn and folded materials (TFM) away from a cutting zone during machining. In other words, second chip groove 86 helps to evacuate any remaining chips or metallic debris removed during machining so that they do not come in contact with the surface to be machined or machined surface.

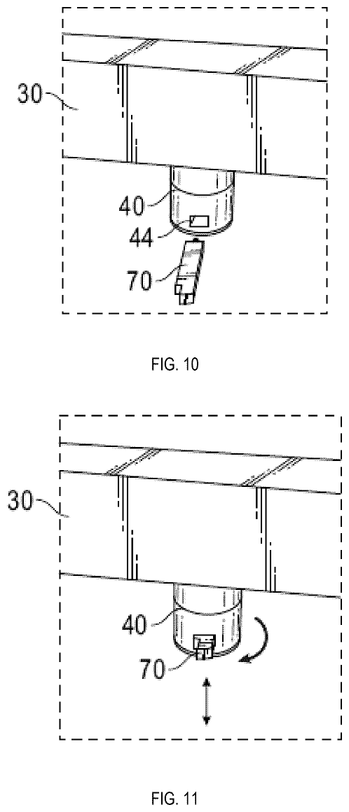

FIG. 10 shows second boring tool insert 70 aligned with tool receiving area 44 of first tool holder 40. Here, second boring tool insert 70 inserts through tool receiving area 44 and second insert clamp 78 connects to the insert connector of first tool holder 40. Second boring tool insert 70 is tightened to properly secure second boring tool insert 70 to first tool holder 40. FIG. 11 shows the feature of second boring tool insert 70 positioned inside second tool holder 70.

In the present embodiment, second boring tool insert 70 is configured to rotate in clock direction. This results in second boring tool insert 70 to rotate in the clock direction such that second cutting edge 82 removes/chips away a portion of material from cylinder bore 22 in a fine boring cycle. When second boring tool insert 70 makes the subsequent pass, the chipped away material gets evacuated via second chip groove 86. This helps to avoid the chipped away material to come in contact with the surface of cylinder bore 22 to be machined. As a result, the formation of torn and folded material (TFM) is eliminated.

Although the above embodiment presents first boring tool insert 50 to rotate in anticlockwise direction (first direction), and second boring tool insert 70 to rotate in clockwise direction (i.e., opposite direction of first boring tool insert 50), it is obvious to a skilled in the art to configure first boring tool insert 50 to rotate in clockwise direction (first direction), and second boring tool insert 70 to rotate in anticlockwise direction (i.e., opposite direction of first boring tool insert 50) without departing from the scope of the present invention. A person skilled in the art understands that the above embodiment is presented to illustrate multiple tools i.e., first boring tool insert 50 or second boring tool insert 70 interchangeably connecting first tool holder 40 at first working head 30 for performing multiple operations.

In one implementation, first display 34 acts as an operational panel for operating first working head 30 in order to machine cylinder bore 22 with tool inserts 50, 70. In one example, first working head 30 includes a first controller (not shown). The first controller is configured for operating first working head 30. First working head 30 includes an interface (not shown) such as a manual and computerized or touchscreen interface. In one example, first display 34 presents the interface for an operator to determine the parameters for operating first working head 30. A person skilled in the art understands that the interface allows the operator to navigate the options provided on first display 34 or set the programmable settings to store and operate first working head 30 based on specific machining profiles. Further, first working head 30 includes a spindle motor (not shown) operatively connected to first tool holder 40.

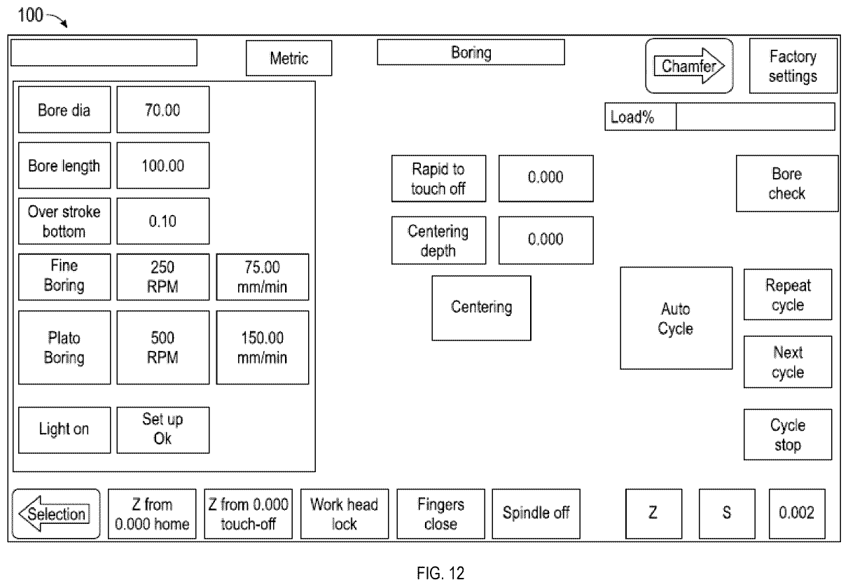

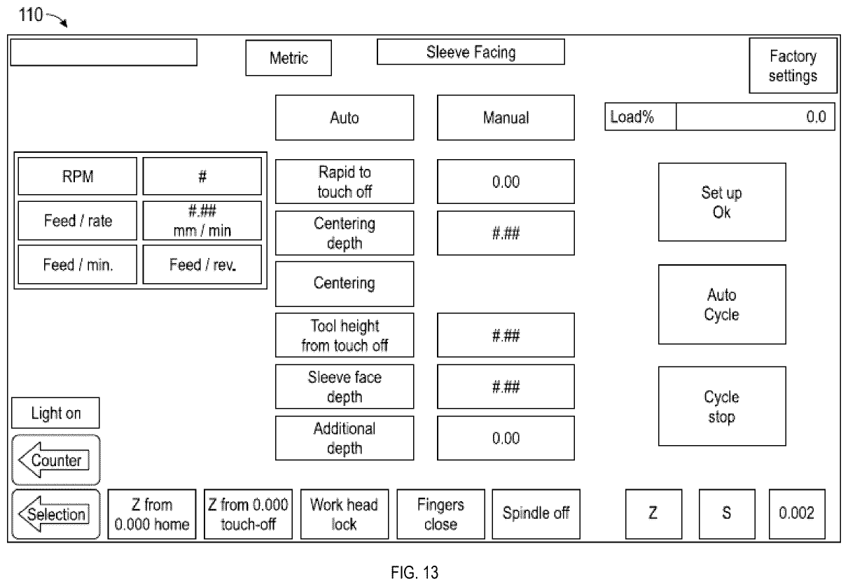

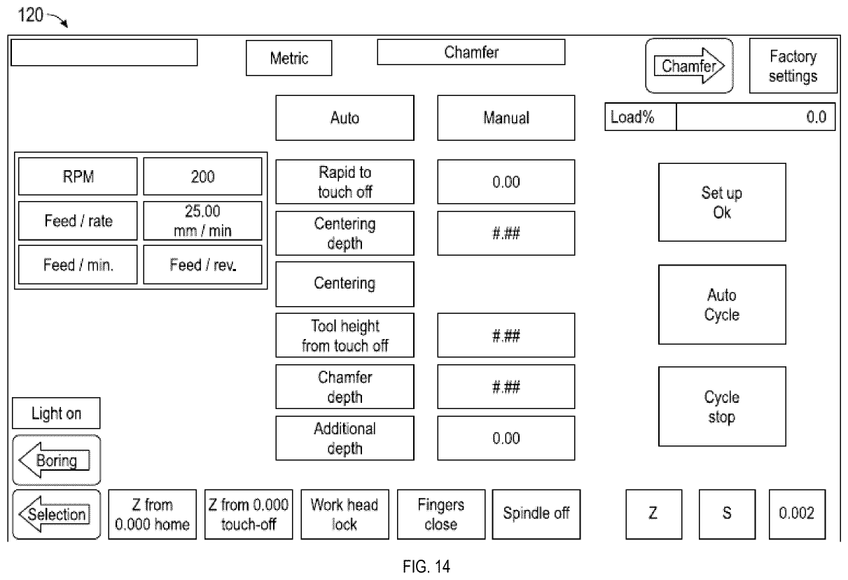

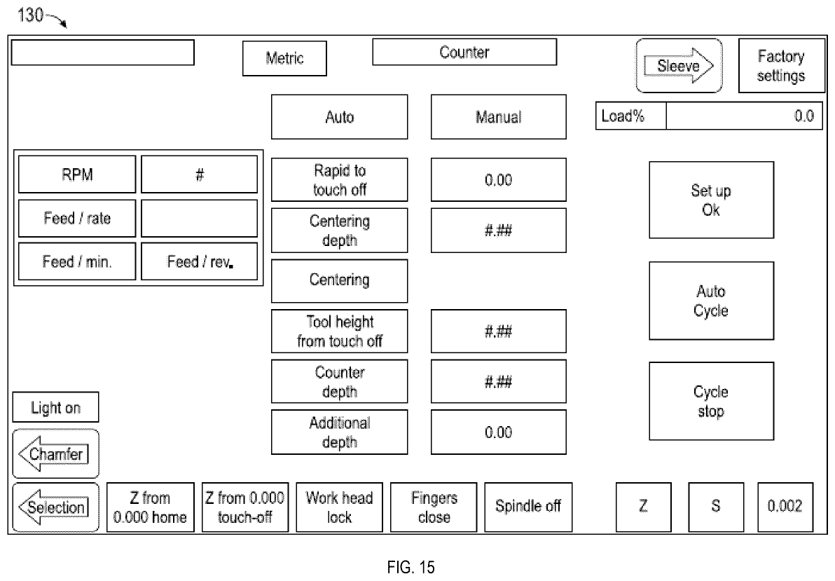

FIG. 12 shows a first interface 100 displayed on first display 34 upon selecting a boring option, in accordance with one exemplary embodiment of the present invention. The options presented in first interface 100 are used to perform boring operation in cylinder bore 22. The boring operation includes enlarging and refining the inner diameter of cylinder bore 22 to desired size, roundness, surface finish, etc. For example, first interface 100 presents options to select the parameters such as bore diameter, bore roundness, centering depth, cutting speed in rotations per minute (RPM) for first boring tool insert 50 and second boring tool insert 70, etc. Further, first interface 100 presents options to select automatic cycle and termination of the operation cycle with a single touch of a button/option presented on first display 34.

FIG. 13 shows a second interface 110 displayed on first display 34 upon selecting the sleeve facing, in accordance with one exemplary embodiment of the present invention. The options presented in second interface 110 are used to perform sleeve facing operation in cylinder bore 22. The sleeve facing operation includes machining or finishing surface of cylinder bore 22. For example, second interface 110 presents options to select the parameters such as facing depth i.e., axial depth to which cylinder bore 22 is to be machined, surface finish, facing feed rate, etc. etc. Further, second interface 110 presents options to select automatic cycle and termination of the operation cycle with a single touch of a button/option presented on first display 34.

FIG. 14 shows a third interface 120 displayed on first display 34 upon selecting a chamfer option, in accordance with one exemplary embodiment of the present invention. The options presented in third interface 120 are used to perform chamfer operation in cylinder bore 22. Chamfer process helps to add a beveled edge to the entrance or exit of the machined surface i.e., cylinder bore 22. Here, chamfering is applied to edges of cylinder bore 22. For example, third interface 120 presents options to select the parameters such as chamfer width and length, chamfer angle, surface finish, feed rate, etc. Further, third interface 120 presents options to select automatic cycle and termination of the operation cycle with a single touch of a button/option presented on first display 34.

FIG. 15 shows a fourth interface 130 displayed on first display 34 upon selecting a counter option, in accordance with one exemplary embodiment of the present invention. The options presented in fourth interface 130 are used to perform countering operation in cylinder bore 22. Counter process includes creating a counterbore at the top of cylinder bore 22 to accommodate components such as valve seats, for example. For example, fourth interface 130 presents options to select the parameters such as counterbore diameter, counterbore depth, counterbore angle, feed rate, etc. Further, fourth interface 130 presents options to select automatic cycle and termination of the operation cycle with a single touch of a button/option presented on first display 34.

Referring back to FIG. 3 and FIG. 4, second working head 32 includes a second tool holder or second spindle 90. Second tool holder 90 extends downward from second working head 32. In one example, second working head 32 includes a surfacing member (abrasive wheel) 92 having a flat grinding surface 94 (FIG. 2). Surfacing member 92 comes in a flat rectangular configuration. In one example, second working head 32 includes a motor (not shown) operatively connected to second tool holder 90. In accordance with the present invention, second working head 32 is used for performing surfacing operation on a workpiece, say on a cylinder block. Here, the surfacing operation is performed to grind cylinder blocks, which are the main parts of an engine that contain the pistons and cylinders. Grinding is a process that uses a rotating abrasive wheel to smooth and shape a surface. In the case of cylinder block surfacing, the grinder removes a small amount of material from the surface of the cylinder bores in order to improve the surface finish, restore the original size and shape of the cylinder bores and remove any imperfections from the cylinder bores.

Second working head 32 includes a second display 36. Second display 36 acts as an operational panel for operating second working head 32 in order to surface workpiece, say second workpiece 20b with surfacing member 92. In one example, second working head 32 includes a second controller (not shown). The second controller is configured for operating second working head 32. Second working head 32 includes an interface (not shown) such as a manual and computerized or touchscreen interface. In one example, second display 36 presents the interface for an operator to determine the parameters for operating second working head 32. A person skilled in the art understands that the interface allows the operator to navigate the options provided on second display 36 or set the programmable settings to store and operate first working head 30 based on specific machining profiles. Further, second working head 32 includes a spindle motor (not shown) operatively connected to second tool holder 90.

In one example, both first working head 30 and second working head 32 can be used to perform different machining operations on a single workpiece say second workpiece 20b in series/sequential manner. Consider second workpiece 20b is a cylinder block. At first, first working head 30 is used to perform boring operation in cylinder bore 22 of second workpiece 20b. Here, second workpiece 20b is affixed to second fixture 18b such that cylinder bore 22 to be machined faces first tool holder 40. Subsequently, the operator inserts first boring tool insert 50 in first tool holder 40 via tool receiving area 44. Subsequently, the operator determines the parameters for boring operation. As specified above, the operator determines bore diameter, bore roundness, centering depth, cutting speed in rotations per minute (RPM) for first boring tool insert 50, etc. After setting the parameters, the operator initiates a boring cycle i.e., first tool holder 40 to perform boring operation in cylinder bore 22 by selecting the automatic cycle option in first interface 110. Subsequently, first tool holder 40 starts rotating in anti-clock direction while advancing axially into cylinder bore 22. As first tool holder 40 rotates in the anti-clock direction, the boring operation is termed as “reverse boring cycle” or “reverse platoboring”.

At first, first tool holder 40 centers itself with respect to cylinder bore 22. After centering, first tool holder 40 advances axially such that first cutting edge 62 of first boring tool insert 50 comes in contact with the surface of cylinder bore 22. First cutting edge 62 removes a portion of material from cylinder bore 22 with each pass/rotation as it comes in contact with the surface of cylinder bore 22. In one example, first cutting edge 62 helps to remove 75 microns of the required 100 microns' depth with rough finishing (rough boring cycle). The material that is removed or debris formed gets collected at first chip groove 66. This ensures there is no material debris left at the surface of cylinder bore 22 to be machined. In one example, first cutting edge 62 is configured to remove say up to 75 microns' depth. First working head 30 operates first tool holder 40 until 75 microns' depth of machining is achieved.

In one example, the first controller operatively connects to a rotary encoder (not shown). The rotary encoder is configured to provide feedback to the controller of accurate position for rotating components such as first tool holder 40 and first boring tool insert 50. The position information such as rotational speed of first tool holder 40 and first boring tool insert 50 helps the controller to precisely determine the location of first boring tool insert 50 with respect to cylinder bore 22 and control and adjust the machining speed/depth during the machining process. Further, the rotary encoder provides continuous feedback to the controller to adjust and/or optimize the machining process in real-time in order to enhance the precision and consistency during the machining. In addition, the rotary encoder captures the precision achieved in a machining process and allows the controller to repeat the machining process to achieve overall accuracy and repeatability of the cylinder bore machining.

After cutting the material (say about 75 microns) from cylinder bore 22 with first boring tool insert 50, first tool holder 40 is retracted axially and first boring tool insert 50 is removed from first tool holder 40. Subsequently, second boring tool insert 70 is connected to first tool holder 40 via tool receiving area 44. Further, the operator determines the parameters such as surface finish required, cutting speed in rotations per minute (RPM) for second boring tool insert 70, etc. After setting the parameters, the operator initiates a fine boring cycle i.e., first tool holder 40 to perform boring operation in cylinder bore 22 by selecting the automatic cycle option in first interface 100. Subsequently, first tool holder 40 starts rotating in clockwise direction while advancing axially into cylinder bore 22. Here, first tool holder 40 centers itself with respect to cylinder bore 22. After centering, first tool holder 40 advances axially such that second cutting edge 82 of second boring tool insert 70 comes in contact with the surface of cylinder bore 22. Second cutting edge 82 smoothens the surface by removing finer material of up to 25 microns from cylinder bore 22 to achieve the required surface finish. The material that is removed or debris formed gets collected at second chip groove 86. This ensures there is no material debris left at the surface of cylinder bore 22 and eliminates torn and folded material (TFM) left in cylinder bore 22.

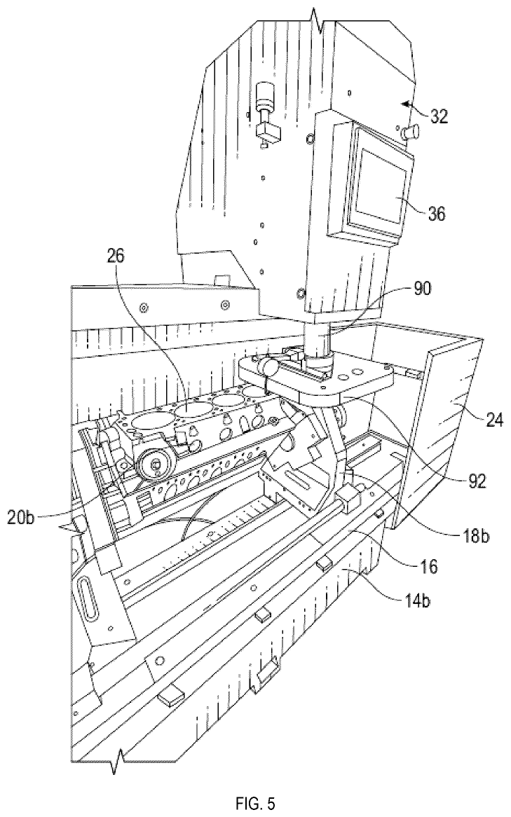

After completing the boring operation, first working head 30 is made to slide such that second working head 32 is brought over second workpiece 20b to perform surfacing operation on cylinder surface 26 of second workpiece 20b. In one example, first working head 30 is made to offset with second workpiece 20b to prevent from interfacing with surfacing operation. In another example, first working head 30 is made to slide over to align with first machining bed 14a. FIG. 5 shows the feature of second working head 32 aligned over second workpiece 20b while first working head 30 is made slide away from second workpiece 20b, in accordance with one embodiment of the present invention. Here, second working head 32 is operated to perform surfacing over cylinder surface 26 using surfacing member 92. Second working head 32 slidably moves from one end of second workpiece 20b to another for performing the surfacing operation on second workpiece 20b. In one example, surfacing member 92 helps to achieve surface finish of 0.2 Ra m. After performing the surfacing operation, second workpiece 20b is removed in order to affix another workpiece, or second workpiece 20b is made to slide over rail 14 aligning with first machining bed 14a. This embodiment allows the machining system 10 to perform multiple operations on the same second workpiece 20b using different working heads 30, 32 without removing or repositioning the workpiece (i.e., second workpiece 20b).

In some implementations, first workpiece 20a is positioned over first machining bed 14a, second workpiece 20b is positioned over second machining bed 14b, and third workpiece 20c is positioned over second machining bed 14c. Further, first working head 30 is positioned over first workpiece 20a and second working head 32 is positioned over second workpiece 20b. Here, each of first working head 30 and second working head 32 may be operated to perform separate machining operations simultaneously on first workpiece 20a (say cylinder boring operation) and second workpiece 20b (surfacing operation), respectively. Here, first working head 30 and second working head 32 are operated independently and simultaneously to perform different operations. As specified above, each of first working head 30 and second working head 32 includes a respective controller to operate them individually. After aligning first working head 30 and second working head 32 with first workpiece 20a and second workpiece 20b, respectively, displays 34, 36 are operated to determine the operations parameters. Subsequently, first working head 30 and second working head 32 are operated simultaneously to perform boring and surfacing operations on first workpiece 20a and second workpiece 20b, respectively. This embodiment allows the machining system 10 to perform multiple operations on multiple workpieces 20a, 20b using different working heads 30, 32 simultaneously while being independent of each other. In a scenario where third workpiece 20c requires surfacing operation to be performed, first workpiece 20a is removed from first fixture 18a, and second workpiece 20b is made to slide over to first machining bed 14a via rail 16. Subsequently, third workpiece 20c is made to slide and align with second working head 32. Further, second working head 32 is operated to perform surfacing machining over third workpiece 20c, as explained above. The above embodiment is presented to illustrate multiple working heads used for performing multiple machining operations on different workpieces simultaneously. Optionally, the working heads may be arranged to perform the multiple machining operations on different workpieces in a sequential manner depending on the need.

A person skilled in the art understands that the above description has been explained to present exemplary embodiments and it is possible to modify the configurations of the machining system to perform one or more machining operations simultaneously or sequentially depending on the need. In one example, the machining system can be used with a single expandable bed, a single fixture receiving a workpiece and a single working head. Here, the single working head can be used to perform one or more machining operations on the workpiece, while allowing other unused workpieces to be placed on the remaining space of the expandable bed. In another example, the machining system can be used with one or more expandable beds, one or more fixtures receiving one or more workpieces and one or more working heads in a variety of configurations. Here, one or more working heads can be used to perform one or more machining operations on the workpieces, while allowing other unused workpieces to be placed on the remaining space of the expandable bed. When needed, the one or more working heads are aligned with the workpieces to perform the required machining operations.

The presently disclosed machining system with expandable machining bed allows it to have multiple working heads. This helps to perform simultaneous boring, honing and surfacing operations on different workpieces simultaneously. In some instances, multiple operations say boring and surfacing operations can be performed on a single workpiece without having to realign or remove from the fixture. This greatly reduces the time to setup and adjust the alignment of the workpieces before the operation is performed. In other words, the machining system with expandable machining bed eliminates the need for repeated setups and realignments. Further, the machining system with expandable machining bed minimizes the downtime between various operations and maximizes operational efficiency. Furthermore, the expandable machining bed minimizes the need for frequent loading and unloading of the workpieces. As a result, handling time and the risk of damage to workpieces reduces drastically.

A person skilled in the art appreciates that the machining system with expandable machining bed can come in a variety of shapes and sizes depending on the need. Further, many changes in the design and placement of components may take place without deviating from the scope of the presently disclosed machining system with expandable machining bed.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention. cm We claim:

1. A machining system having an expandable machining bed for performing machining operations, said machining system comprising:
a base having an expandable machining bed;
a plurality of fixtures positioned on said machining bed, wherein said plurality of fixtures is configured to secure a plurality of workpieces; and
at least one working head positioned above said machining bed, wherein said at least one working head is configured to perform machining operations that are same or different from one another on one or more workpieces of said plurality of workpieces.

2. The machining system of claim 1, wherein said expandable machining bed comprises a first machining bed and a second machining bed, and wherein one of said first machining bed and said second machining bed is selectively used to receive said one or more workpieces via said plurality of fixtures.

3. The machining system of claim 2, wherein said at least one working head comprises a first working head and a second working head, wherein said first working head is configured to perform a first machining operation of said machining operations, wherein said second working head is configured to perform a second machining operation of said machining operations, and wherein said first machining operation and said second machining operation are independent and different from each other.

4. The machining system of claim 3, wherein said first working head and said second working head are configured to slide and align with said plurality of workpieces in a sequential manner, or simultaneously to perform machining operations that are same or different from one another.

5. The machining system of claim 1, wherein said machining operations comprises one of a boring operation, a honing operation, a valve seat cutting operation, and a surfacing operation.

6. The machining system of claim 1, wherein said at least one working head comprises a first tool holder and a second tool holder.

7. The machining system of claim 1, wherein said first tool holder comprises a tool insert for performing a machining operation of said machining operations on a workpiece of said plurality of workpieces, and wherein said machining operation comprises one of a boring operation, a honing operation, a valve seat cutting operation, and a surfacing operation.

8. The machining system of claim 1, wherein at least one working head comprises a controller for performing sequential machining operations on said one or more workpieces.

9. The machining system of claim 1, wherein said expandable machining bed comprises a rail, and wherein said rail receives said plurality of fixtures.

10. The machining system of claim 9, wherein said plurality of fixtures is slidable along said rail.

11. The machining system of claim 10, wherein said at least one working head is made to slide and align with a workpiece of said plurality of workpieces for performing a machining operation of said machining operations.

12. The machining system of claim 1, said at least one working head comprises a display for adjusting operational parameters for performing said machining operations.

13. A machining system having an expandable machining bed for performing machining operations, said machining system comprising:
a base having an expandable machining bed;
a first fixture and a second fixture positioned on said machining bed, wherein said first fixture is configured to secure a first workpiece and a second fixture is configured to secure a second workpiece; and
a first working head and a second working head positioned above said machining bed, wherein said first working head and said second working head positioned are slidable, wherein said first working head is configured to perform a first machining operation, wherein said second working head is configured to perform a second machining operation, wherein said first machining operation is independent and different from said second machining operation,
wherein said first working head is made to slide and align with said first workpiece for performing said first machining operation, followed by sliding said second working head to align with said second workpiece for performing said second machining operation in a sequential manner, or
wherein said first working head is made to slide and align with said first workpiece for performing said first machining operation, and said second working head is made to slide and align with said second workpiece for performing said second machining operation, simultaneously.

14. The machining system of claim 13, wherein said first machining operation and said second machining operation comprises one of a boring operation, a honing operation, a valve seat cutting operation, and a surfacing operation.

15. The machining system of claim 13, wherein each of said first working head and said second working head comprises a respective controller for operating independently and performing simultaneous or sequential said first machining operation and said second machining operation on said first workpiece and said second workpiece, respectively.

16. The machining system of claim 13, wherein said expandable machining bed comprises a rail, and wherein said rail receives said first fixture and said second fixture.

17. The machining system of claim 13, each of said first working head and said second working head comprises a display for adjusting respective operational parameters for performing said first machining operation and said second machining operation, respectively.

18. A method for operating a machining system with an expandable machining bed to perform machining operations, said method comprising the steps of:
providing a base having an expandable machining bed;
providing a plurality of fixtures positioned on said machining bed, said plurality of fixtures securing a plurality of workpieces;
providing at least one working head positioned above said machining bed; and
performing machining operations that are same or different from one another on one or more workpieces of said plurality of workpieces using said at least one working head.

19. The method of claim 18, further comprising providing a controller at said at least one working head for performing sequential or simultaneous machining operations on said one or more workpieces.

20. The method of claim 18, further comprising:
configuring said expandable machining bed to have a first machining bed and a second machining bed, such that one of said first machining bed and said second machining bed is selectively used to receive said one or more workpieces via said plurality of fixtures;
configuring said at least one working head to have a first working head and a second working head;
performing a first machining operation of said machining operations using said wherein said first working head; and
performing a second machining operation of said machining operations using said second working head, said first machining operation and said second machining operation being independent and different from each other.
